(19) United States
(12) Patent Application Publication
(10) Pub. No.: US 2022/0352924 A1
(43) Pub. Date: Nov. 3, 2022

(54) Electromagnetic Communication Method

(71) Applicant: Elmer Griebeler, Chesterfield, OH (US)

(72) Inventor: Elmer Griebeler, Chesterfield, OH (US)

(21) Appl. No.: 17/855,988

(22) Filed: Jul. 1, 2022

Related U.S. Application Data
(63) Continuation-in-part of application No. 16/422,582, filed on May 24, 2019.
Application No. 16/422,582 is a continuation-in-part of application No. 15/621,201, filed on Jun. 13, 2017, now Pat. No. 9,955,564.
Application No. 15/621,201 is a continuation-in-part of application No. 14/617,461, filed on Feb. 9, 2015, now abandoned.

(51) Int. Cl. H04B 1/717; H04B 1/7176; H04B 1/719; G01S 13/88; G01S 13/89

(52) U.S. Cl. CPC H04B 1/7172; H04B 1/7176; H04B 1/719; G01S 13/885; G01S 13/89

(57) ABSTRACT

A communication method comprising a transmitting method that creates a series of repeated pieces of a time-spaced pattern that contains no repeated spacing sizes or patterns; creating a plurality of non-resonant step wave shapes spaced according to the repeated pieces of the time-spacing pattern; converting the step wave shapes into a plurality of electromagnetic waves; a receiving method comprising converting said electromagnetic waves into an electrical signal; wherein the step wave shape is recognized in the signal; wherein the time-spacing pattern is recognized in the sequence of the step wave shapes; whereby data can be encoded by introducing variation into the step wave shapes, to change one or more properties of the time-spacing pattern, or change the amplitude of portions of the step waves.

### CROSS REFERENCE TO RELATED APPLICATIONS

This application is a continuation-in-part of, and claims the benefit of, U.S. patent application Ser. No. 16/422,582, filed May 24, 2019, entitled “Electromagnetic Communication Device,” which is a continuation-in-part of application Ser. No. 15/621,201, filed Jun. 13, 2017, entitled “Electromagnetic Pulse Device,” which is a continuation-in-part of application Ser. No. 14/617,461, filed Feb. 9, 2015, which is entitled “Electromagnetic Pulse Device,” and is incorporated herein by reference.

### BACKGROUND OF THE INVENTION

The present invention is directed to a method that uses a series of electromagnetic field strength shifts or steps spaced out in time according to a unique spacing pattern to transmit data without interference with conventional radio and to effectively add an alternative to the crowded radio spectrum. Herein these transmitted waves are called step waves.

Radio waves are continuous resonances or oscillations, or short duration pulses or bursts of oscillations such as with radar, for example. Spikes or pulses from electrical sparks and lightning are also examples of electromagnetic pulses. Electromagnetic spikes are usually subject to a decaying resonance due to complex impedance encountered in electrical circuits similar to a bell ringing, fading to silence. It is essentially a damped sinusoidal wave whose amplitude approaches zero as time increases. For the purpose of the step wave mode communication of the present invention, all resonances and oscillation are avoided in order to distinguish the step wave from the radio wave and also to avoid interfering with existing radio communication or radio communication interfering with step wave communication.

### SUMMARY OF THE INVENTION

The present invention is directed to a communication method comprising a transmitting method comprising creating a series of repeated pieces of a time-spacing pattern that contains no repeated spacing sizes or patterns; creating a plurality of step wave shapes spaced according to said repeated pieces of said time-spacing pattern; converting said step wave shapes into a plurality of electromagnetic waves; a receiving method comprising converting said electromagnetic waves into an electrical signal; wherein said step wave shape is recognized in said signal; wherein said series of pieces of a time-spacing pattern is recognized in the series of said recognized step wave shapes; whereby data can be encoded by introducing variation into said step wave shapes, to change one or more properties of said step-spacing pattern, or change the amplitude of portions of the said step-spacing pattern.

The invention is further directed to a communication apparatus that uses the communication method of claim 1 comprising a transmitting apparatus comprising a first clock having at least one clock cycle, and at least one binary counter timed by said first clock; a transmitter antenna; a memory containing the length of the said number pattern piece and the execution rate of said piece; a first sequencer that creates said number pattern that is the reversed binary number from said binary counter timed by said clock; wherein said first sequencer repeats said piece of said number pattern to create a repeating piece of said number pattern; wherein said first sequencer creates a time-spacing pattern that is a series of time spaces equal to a number of clock cycles assigned to each time space dictated by said repeating piece of said number pattern; a power source that creates one or more step waves, each step wave having an initial level, having a curved top up to a maximum level and a slow recovery back down to said initial level; wherein said step waves are spaced according to said time-spacing pattern; wherein said antenna converts said step waves into a plurality of step electromagnetic waves; a receiving apparatus comprising a receiver antenna to convert said step electromagnetic waves to a plurality of electrical signals; a step wave shape recognition circuit that recognizes said electrical signals; an automatic gain control circuit that controls the amplitude of the said recognized signals; a second clock having at least one clock cycle and at least one binary counter timed by said second clock; a memory containing the length of the piece of the number pattern and the execution rate of said piece; a second sequencer that creates said number pattern that is the reversed binary number from the binary counter timed by said second clock; wherein said second sequencer that creates a repeating piece of said number pattern; wherein said second sequencer creates a time-spacing pattern that is a series of time spaces equal to the number of said clock cycles assigned to each time space dictated by said repeating piece; a phase-lock-loop circuit that compares said time-spacing pattern with the pattern of said recognized signal to adjust the second clock to synchronize with said first clock.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is an illustration of the step wave used in the present invention;

FIG. 2 is a chart showing a method to form a spacing pattern;

FIG. 2A is an illustration of a series of step waves with and without encoded data;

FIG. 3 is a chart of a portion of the step wave spectrum;

FIG. 4 is a block diagram of one apparatus to transmit and receive step waves; and

FIG. 5 is a diagram of the step wave with a typical antenna.

### DETAILED DESCRIPTION OF THE INVENTION

The present invention is directed to a step wave of a voltage, current, electric field, or magnetic field that repeatedly steps from one strength level to a higher strength with a slower decay back to starting strength between steps. The step shape is curved to minimize resonances in antennas, circuits, and other metallic objects in the environment, and the steps are spaced according to a piece of a unique pattern that contains no repeated spacing sizes or repeated patterns. The spacing pattern is based on a reversed binary number from a counter of arbitrary length. The unique reversed binary pattern could go on forever, but to be useful for creating independent transmissions, the unique pattern is stopped after some chosen, arbitrary point and started over from the beginning. The length of these unique pattern pieces, the overall rate of transmission of the steps that follow this unique pattern, and the slope of the steps may be hereafter referred to as a spacing plan. The large variety of possible values that can be chosen for these three parameters creates a large new spectrum.

The spacing plan, step waves, and step spacing method of this invention offer a type of electromagnetic radiation that does not occur in nature nor is used in radio communications and thereby is recognizable even with the interference of natural electromagnetic noise. The unnatural shape of the step wave and the spacing plan introduces human intelligence (reduced entropy) into the wave and thereby makes this step wave highly recognizable against the randomness (higher entropy) of the environment. As will be discussed below, the decimal equivalent of the reversed binary sequence results in a non-repeating, non-natural number sequence so it somewhat resembles noise, and would not be confused for a normal radio signal. But when this entire sequence is repeated and combined with an averager, it begins to stand out against the random noise of the background.

### Purpose of the Invention

The primary purpose of the step wave is to create a new large spectrum to reduce the crowding of the radio spectrum. The step wave has the added benefit of much longer range than radio at comparable average power. Also, the step wave has good security in that present radio technology cannot detect this step wave and the step wave spectrum is very large. This large spectrum makes the step wave difficult to find if one does not know the chosen step spacing plan.

### Challenges

The spacing between the steps reduces the maximum data rate, typically to the rate of the steps. Also, to tolerate interference and to discriminate between step wave channels, the spacing pattern pieces need to be repeated and these repeats averaged together. New hardware and software are needed to use step waves.

### Detailed Description of the Figures

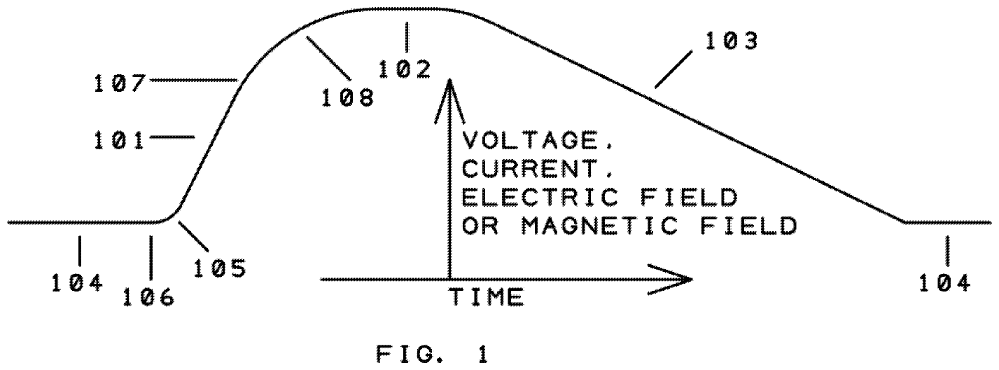

As shown in FIG. 1, each step is a steep ramp 101 up of voltage, current, electric field, or magnetic field to a new steady level 102. This new level must then decay 103 back to the original level 104 in preparation for the next step wave. A simple step that has only these features will cause unwanted electromagnetic resonances in circuits, antennas and metal objects, making the step indirectly detectable in unintended ways, and causing radio interference. The step of the present invention does more than this, however. To prevent this unwanted resonance, the step wave ramp of the present invention does not start suddenly; it must curve up (a finite acceleration) 105 from a zero ramp slope 106. Then, about 70% up 107 to the new level, the ramp slope 108 needs to progressively decrease down to zero ramp slope at the new, higher steady level 102. 70% is not a hard and fast point, but was determined by trial and error. Outside of this 70% range, the step waves tend to introduce unintended, and undesirable, resonance. The actual progressive decrease in slope is necessary to reduce the tendency to cause resonances and is determined by the application. Such a step wave has a typical rise time of about a nanosecond and a decay time of about ten nanoseconds. Typically, the waves are identical; the data encoding will be discussed below. The steps are typically spaced far apart, on the order of ten times to 100,000 times the time scale of the wave shown in FIG. 1.

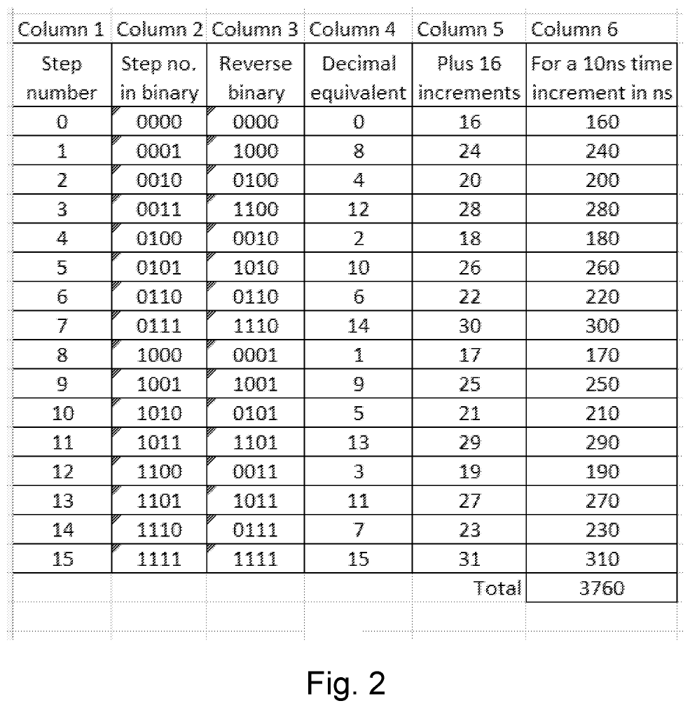

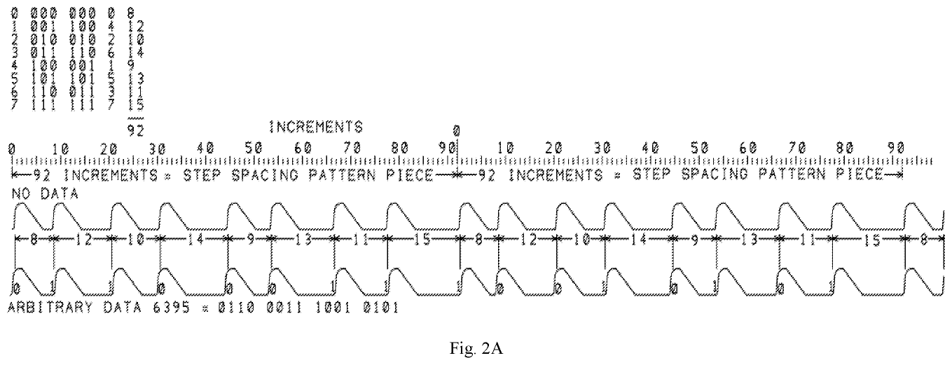

The step waves are spaced according to a unique pattern that contains no repeated spacing sizes or repeating patterns that could be interpreted as a frequency. The pattern is created by using the binary number created by reversing the bits in a binary counting sequence. See FIG. 2. The resulting reversed binary number counting sequence is used to create the time space between each pair of steps. This unique spacing pattern is actually an infinite sequence; to be useful, the unique pattern is stopped after a short arbitrary time and repeated, forming a series of identical repeating pieces of the unique spacing pattern. In the example shown in FIG. 2, the unique spacing pattern piece length is 16 steps, but the length/number of steps is arbitrary and is chosen by the user.

As shown in FIG. 2, Column 1shows the 16 steps, 0 to 15, in decimal. Column 2 shows that same list in binary (0000 to 1111). Column 3 shows the binary number reversed, where the bits are flipped or mirrored (e.g. 0001 becomes 1000). Column 4shows that reversed/flipped/mirrored binary number as a decimal. The result is a unique sequence that is not random and has a new uniform distribution of the original count sequence. To give this unique sequence a rage of 2:1, the size of the original count 16 is added to this as shown in column 5.16, in this case is the pattern length piece. With an increment size of 10 ns, the spacing between each step is shown in column 6.

In the example shown in FIG. 2, when the spacing pattern piece is sent, the first step wave (step 0) is sent. 160 ns later the second step wave (step 1) is sent. 240 ns after the second step, the third step wave (step 2) is sent, and so on. After the 15^{th} step wave (step 14) is sent, there is a 230 ns delay and the last step wave (step 15) is sent. After an additional 310 ns delay, the spacing pattern piece repeats, and the process discussed in this paragraph begins again (i.e. step 0 is sent again).

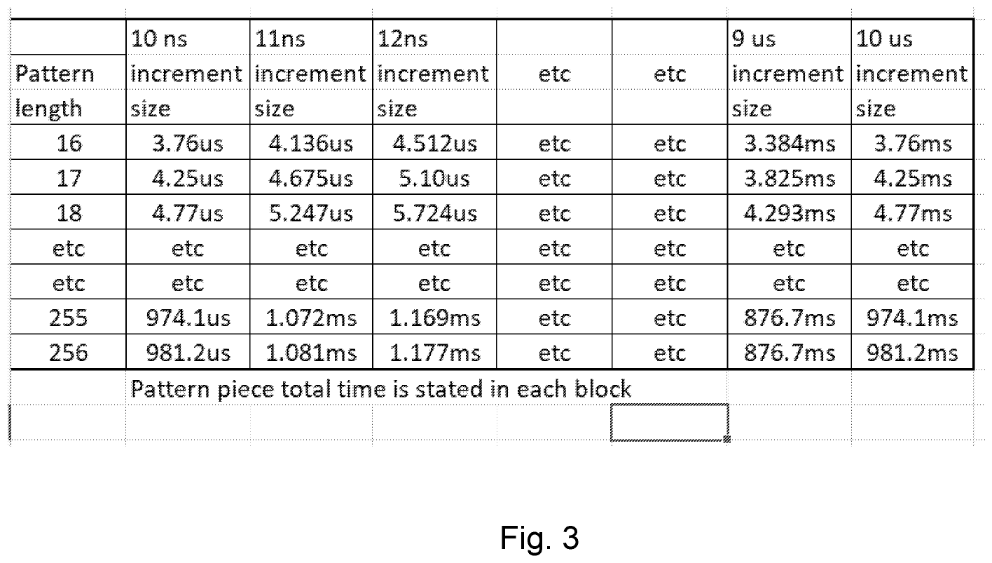

As shown in FIG. 2, the spacing varies from 16 to 31 time increments, giving an average of 23.5 time increment units ((31+16)/2). The total of the time increments determines the rate of execution of the spacing pattern. As shown in FIG. 2, a 10 ns time increment is chosen, but this can be chosen to be any arbitrary rate. (See FIG. 3, which shows time increment rates of 11 ns, 12 ns, up to 10 μs. There is no upper limit, however, the larger the time increment, the longer it takes to send the message, so extremely large time increments are inefficient and/or unfeasible, although possible. 16 is arbitrary but is chosen here because of the popularity of 16-bit chip formats.

FIG. 2A shows an 8 step long spacing pattern piece, showing the 8 different spacings. An 8 step long spacing pattern piece is chosen here for ease of illustrating this figure and is just one of many possible lengths. In reality, the steps are spaced much farther apart to allow energy accumulation between the steps, but are shown here closely spaced (i.e. not to scale) for the ease of illustrating the concept. The upper wave is a wave following the spacing pattern piece sequence. The lower wave contains a binary number encoded by modulating the timing of the steps. The binary one is indicated by shifting the step wave to the right and the zero is indicated by shifting the step wave to the left. In the receiver, these small time shifts will cause small errors in the phase-lock-loop which thereby provides the binary data output desired. This method of encoding data into the step wave pattern is only one of many possible methods, which are discussed below.

The different possible lengths of the unique pattern piece in combination with the range of possible spacing pattern execution rates, and the range of step slopes produces a large number of possible independent communication channels and constitute this new large spectrum. A shorter pattern piece (8 steps or less) may be useful for broadcasting where a large spectrum or security is not needed. A small part of only the spacing pattern piece lengths and piece repeat rates is shown. Different step slopes creates another dimension to FIG. 3, like pages in a book. These “pages” would all have the same spacing pattern piece lengths and piece repeat rates, but different step slopes. Looking at the first line of FIG. 3, the spacing plan has 16 steps in the step spacing pattern piece and has an increment size of 10 ns. (This is the same as shown in FIG. 2.) There will be 16 different spacing sizes with about a 2:1 range of spacing sizes, and the average spacing size of (15+31)/2=23.5 increments. With the increment size of 10 ns in this example, and 16 steps, the pattern piece total time is 23.5×10 ns×16=3760 ns (nanoseconds) or 3.76 us (microseconds/μs).

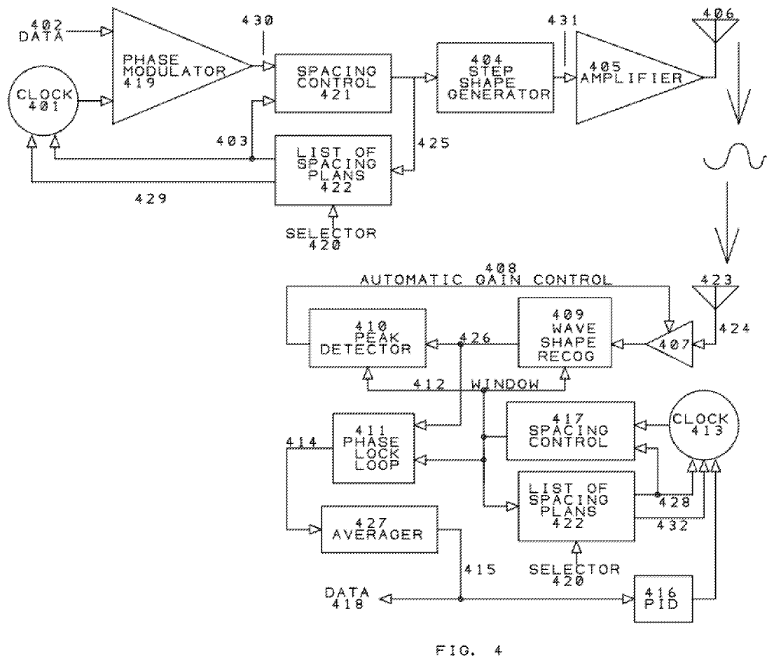

FIG. 4 shows one possible embodiment of an apparatus to use the step spacing pattern method. As shown in FIG. 4, the timing of a precision clock 401 is phase modulated by the data 402 in a modulator 419, producing a phase modulated clock signal 430. (This is only one example of encoding data into the step wave.) The modulated clock signal 430 provides the timing increments for the step spacing and thereby modulates the timing of the steps (see FIG. 2A, lower trace). The number of increments for each step is counted out by the spacing control 421. The spacing control 421 is provided the number of time increments 403 (column 5 of FIG. 2) needed for each space by the chosen spacing plan from an available list 422. The step trigger 425 advances the space size to the next space in the spacing pattern piece.

The chosen spacing plan consists of a repeating length of a piece of the spacing pattern and a time increment size 429. The time increment size 429 is sent to the clock 401 to set the clock rate. The chosen spacing plan comes from a selector 420 which could be a dial or keypad that is preset and known to (agreed upon by) the intended recipient at the receiver, as well as the sender at the transmitter. The number of increments 403 is fed to the clock 401 to modulate the clock frequency one quarter of the resolution of the spacing pattern piece length. For instance, if the spacing pattern piece is 256 steps with 98,120 increments (FIG. 3 second column bottom line (981.2 us/10 ns=98,120 increments)), the clock is modulation ¼ of 10 ns/983 us=2.54e-6 or 2.54 ppm (parts per million). The purpose of this modulation of the clock is to remove the clock frequency signature from the background so that the clock frequency does not appear in a frequency spectrum search.

The step trigger 425 feeds the step shape generator 404 which creates the voltage step shape with a rounded top 431 as shown in FIG. 1. This step shape is amplified via amplifier 405 as needed for the application and sends this amplified wave to the antenna 406 for transmission.

The receiver antenna 423 receives signal 424 which is amplified by amplifier 407 where the signal strength is maintained by the effect of the automatic gain control feedback loop 408. The wave shape recognition processor 409 looks for any step wave shapes and rejects everything else, in particular, radio waves, and passes the recognized step wave shape signal 426 to the peak detector 410 and phase lock loop 411. The peak detector 410 measures the amplitude of the recognized step wave shape signal 426 and provides the automatic gain control feedback loop 408 to maintain a standard amplitude (i.e. it increases power if the amplitude is low and decrease power if the amplitude is high).

The number of increments for each step is counted out by the spacing control 417. The spacing control is provided the number of increments 428 needed for each space in the chosen spacing plan from an available list 422. The window 412 advances the space size to the next space in the spacing pattern piece. The chosen spacing plan consists of a repeating length of a piece of the spacing pattern and a time increment size 432. The time increment size 432 is sent to the clock 413 to set the clock rate. The chosen spacing plan comes from a selector 420 which is preset and is set to match the transmitter, as noted above. The number of increments 428 is fed to the clock 413 to modulate the clock frequency one quarter of the resolution of the spacing pattern piece length. This matches the behavior of the transmitter.

The phase-lock-loop circuit 411 compares the timing of the recognized step wave shape signal 426 with a time window 412 which is generated the same way as the transmitter step trigger 425. The recognized step wave shape signal 426 should line up with the window 412. The phase-lock-loop outputs an error signal 414 indicating any misalignment between 412 and 426 which is used to correct the receiver's clock 413 so that it matches the transmitter's clock 401. To smooth out time domain noise, the error signal 414 is averaged over many steps, from ten to 100,000, as needed for the application. The averaged error 415 is fed back to the clock 413 through a standard PID (proportional integral derivative) control 416 process for control loop stability. The clock 413 works through the spacing control 417 so that not only do the two clocks 401 and 413 match, but the spacing pattern pieces 403 and 428 also line up.

The data output 418 appears as the error signal from the averager 427. The specific spacing plans 403 and 428 are selected to be the same and must be agreed upon beforehand by the sending party and the receiving party as part of the security procedure. The selection of a spacing plan is analogous to a phone number: the sender must know the proper phone number of the receiver to send a message (phone call) to them.

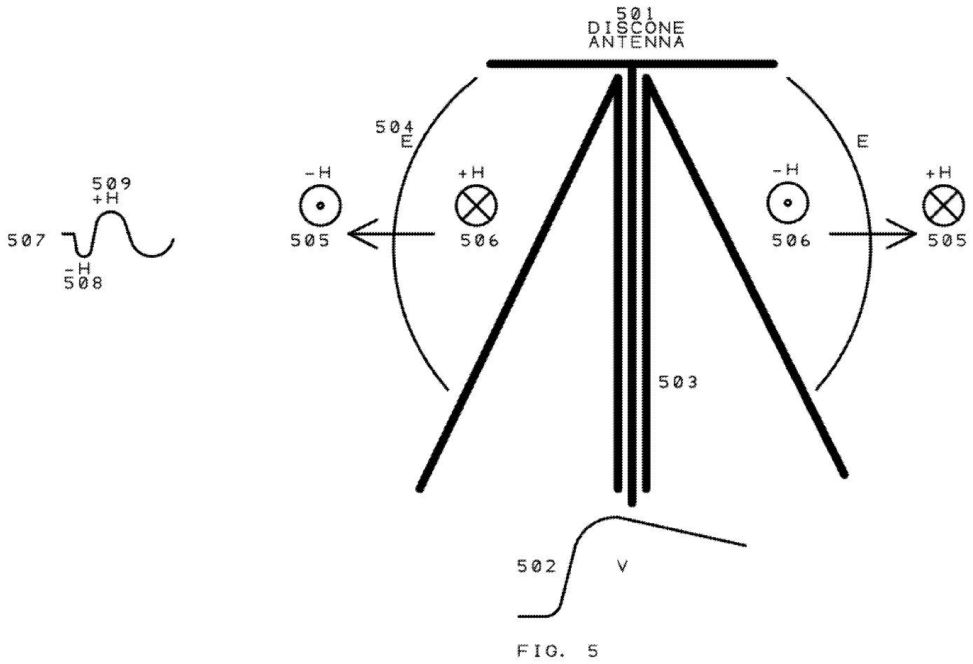

FIG. 5 is a diagram of the step wave as the wave passes through a low resonance wide-band antenna. FIG. 5 shows a discone antenna, but it is not limited to a discone antenna; any low resonance wide-band antenna may be used, but a discone is preferred. The step wave in the form of a voltage 502 is passed through a coaxial cable 503 and appears as an electric field (E) 504 which spreads outward at or near the speed of light. As the electric 504 field is being created from the applied voltage 502, a leading magnetic field (H) 505 is created at right angle to the electric field 504 and wraps around the antenna. Also, another magnetic field (H) 506 is created in the reverse direction to the leading magnetic field 505 but trailing the electric field 504. As shown in FIG. 5, the circle with the dot in the center symbolizes the magnetic field extending out of the plane of the figure/toward the reader, and the circle with the X inside symbolizes the magnetic field extending in the opposite direction, into the plane of the figure/away from the reader in co-planar, concentric toroids 505, 506.

As the electric field 504 and the two magnetic fields 505, 506 expand outwards, the electric field 504 quickly weakens since the electric field is supported by the voltage 502 back at the antenna. The two magnetic fields 505, 506 create their own electric fields that grow to match the shapes of the magnetic fields 505, 506 but at right angles to the magnetic fields 505, 506. The step wave 507 that now propagates away has only the leading electromagnetic field 508 and the trailing electromagnetic field 509, forming an “S” shaped wave.

Because the original step wave voltage 502 curves 108 (in FIG. 1) after the fast rise 101, the propagating wave 507 stretches so that the trailing electromagnetic field 509 is significantly longer than the leading electromagnetic field 508. This stretching is important because no frequency can be determined from this stretched wave shape 507; the frequency continuously changes along the length of this wave. This significantly reduces the detected amplitude of this wave with a Fourier Transform and therefore is a part of the strategy to avoid interference with radio. With this discone antenna, this “S” wave shape is the shape that the wave shape recognition circuit 409 (see FIG. 4) is looking for.

### Data Encoding Methods

The data can be encoded in several different ways, by introducing variation into the pulse-spacing pattern to change one or more properties of the pulse-spacing pattern depending on the application and compromises with distance, data rates needed, and available channels. There are many more methods beyond the scope of this application.
1) One of the possible encoding methods is an analog or binary small time-modulation of the transmit clock; the data is available from the receiver phase-lock-loop error signal. For synchronizing purposes, the error signal responds slowly since it is the average of many spacing pattern pieces. This distinguishes the synchronizing action from the much faster data. This modulation must be kept small to avoid overpowering the receiver's frequency and spacing pattern lock onto the transmitter.
2) Another method is to encode binary numbers in the degree of time-modulation. This provides a higher data rate. This modulation must be kept small to avoid overpowering the receiver's frequency and spacing pattern lock onto the transmitter as shown in FIG. 2A.
3) One method could be to change the slope of some of the steps to indicate binary ones and zeros. The receiver has a slope detector for each slope. Both slope detectors serve the phase-lock-loop to maintain synchronization.
4) The entire spacing sequence could be turned on and off to represent ones and zeros, like with Morse code. Any extended off times need to be filled in with dots to keep the phase-lock-loop synchronized. The actual method to keep the synchronization active is left up to the user.
5) The spacing pattern piece can be alternated with a different spacing pattern piece to indicate the ones and zeroes. Each spacing pattern piece (channel) would have its own phase-lock-loop.
6) The steps in the spacing pattern piece could be a mixture of plus and minus step polarities to indicate the ones and zeroes of the data to be transmitted (i.e. this would work by alternating flipping FIG. 1 upside down). The recognition of both step polarities would also feed the phase-lock-loop to maintain synchronization. This provides a high data rate.
7) Since there are a large number of available channels, the data could be sent in parallel instead of the usual serial sequence, or the data could be spread out amongst several channels to provide added security. Each channel used would have its own phase-lock-loop. This provides the highest data rate.
8) The amplitude or power level of the step waves could be modulated to encode data or act like traditional amplitude modulated transmissions.

### Use of the Step Wave as a Detector

The step wave can be reflected from objects and the reflected waves received by the transmitting antenna or a separate antenna for the purpose of detecting objects in the environment. The step wave shape is simpler which allows for improved distance resolution and simpler reflected wave shapes. Both metals and non-metals reflect radio waves, and so would also reflect the step wave. This offers the opportunity to detect hidden objects better than microwaves due to the higher amplitude of the step wave. (About 10,000 times depending on the application.) The step wave shape is modified by reflection due to the type of the material, the shape of the object, and by the orientation of the object. This makes the step wave useful for weapons, landmine, and IED detection and ground penetrating radar imaging. The receiver section contains extra wave shape recognition functions to respond to each of these modified waves. For example, the device could be directed at a clean, unburied landmine and its reflected wave recorded, where this reflected wave has a unique signature (like a fingerprint) of the landmine/weapon. Then this signature is added to a library of such signatures.

### Notes

Note 1. The step has no oscillations but propagates well. Maxwell's equations do not require the use of sine shaped waves such as radio waves. According to Maxwell's equations, every electric or magnetic disturbance will produce a wave that spreads at the speed of light. Because of the interaction of the electric field with the magnetic field, the waves spread in preferred directions. In the case of the discone antenna, the waves spread predominately horizontally “towards the horizon,” assuming the discone antenna is mounted vertically.

Note 2. Theoretically, any wave can be created by a unique set of sine waves. In the case of this step wave, the unique set of sine waves would be very large and therefore would be of no analytic value. Conversely, any sine wave can be created from a very large set of step waves. This also has no analytic value. This series of electromagnetic steps of this invention use variations of a spacing pattern that allows these steps and their spacing pattern to be easily distinguished from sparks, radio, and background noise.

Note 3. Radio allows many simultaneous communications by using separate frequencies; this can be referred to as frequency domain. Step communication allows many simultaneous communications (channels) by using a unique step spacing pattern cut into pieces of different lengths, spacing pattern rates, and a range of step rise rates 101 (see FIG. 1); this can be referred to as time domain. As an example, a person can tune one's car radio to 107.3 FM and then change to 100.1 FM. This is selecting between 2 different frequencies. Similarly, with this invention, a user could “tune” his/her transmitter to 24 pattern length, 10 ns increment (FIG. 3), and then change his/her transmitter to 255 pattern length, 12 ns increment.

Note 4. One way to clarify what is meant herein by “step” is to consider a step like a shockwave, or like a hammer hitting gel which produces no sound oscillations, as opposed to a hammer hitting a bell which produces oscillations at a definite pitch or frequency. A struck gel produces a single sound spike, whereas the bell will reverberate and produce the characteristic bell ringing sound. There is a great advantage in not producing oscillations since all oscillations are part of the radio spectrum and are subject to the radio spectrum over-crowding. Radio waves, microwaves, visible light, x-rays, and gamma rays are all electromagnetic oscillations.

This is not to suggest that the step is not a “wave” since a wave can be a spike or an oscillation. An example of a spike is a shockwave or soliton wave; neither has oscillations. The soliton wave does not exist with electromagnetic waves in free space.

Note 5. The strength of electromagnetic waves vary enormously. If a receiver is close to a transmitter being used for some other purpose such as radio broadcasting, the transmitted signal will be very large and the tendency for that transmitter to interfere will be huge. To handle this extreme situation and every lesser situation, the step method must specifically look for the unique step wave shape and the spacing pattern length and the step rate the transmitter is using. Conversely, if a radio receiver is near a powerful step transmitter, the step wave shape must not contain any frequency and the step spacing pattern must not have any repeating details that could be received as a radio frequency. According to this invention, there is only one such non-interfering spacing pattern, as described above. Theoretically, even the clock that establishes the spacing pattern will leave a very weak pattern of itself in the transmission. To counteract this, the phase of the clock is modulated according to the step spacing pattern. The receiver is set up to match this behavior and easily accommodates this phase movement.

Note 6. Typically, each step wave channel will have its own spacing pattern piece length and pattern execution rate. The length times the rate gives the rate at which the pattern piece repeats. This repeat rate is chosen to be lower than any radio frequency of concern, typically below 10 kilohertz (kHz).

Note 7. Radio uses a continuous wave of constant power. The step of the present invention accumulates energy between each step and releases that energy at the moment of the rise of the step. If the rise time of the step is one nanosecond and the typical space between steps is ten microseconds, that could be a 10,000 to 1 concentration of the transmit energy. If a radio is transmitting one Watt and has a range of one mile, a step transmitter with the same one Watt average will transmit 10,000 Watt surges with a range of 100 miles. This is a large advantage for low power or long range applications.

Note 8. The receiver averages many repeats of the spacing plan to reject other patterns and to increase the signal strength above ambient noise. An example arrangement is an average of one million steps per second with 100 repeats with a spacing code length of 100 steps. The steps are typically 1 ns (0.000,000,001 second) and a data rate of 10,000 bits per second. A comparable radio would be 1 GHz with a bandwidth and of 100 kHz with a data rate of about 100,000 bits per second.

Note 9. The step signal does weaken by the inverse square law, just like radio signals. The amplifier in the receiver raises the signal amplitude back up as needed to an established standard, such as, for example, one volt, but also amplifies noise. The averager accumulates and strengthens the signal and at the same time suppresses the noise which naturally averages toward zero due to its randomness and lack of correlation with the pattern of the signal. This greatly extends the range of this step technology. Radio has a similar function by introducing resonant filters in the signal path that select for the frequency the radio is tuned to. Tests have shown the step wave to be the same as radio when it comes to tunability. As far as range, the step wave hugely outperforms radio, depending on setup, typically about ×100 more distance. However, there is a trade-off: it trades distance for data transfer rate.

Note 10. Step communication needs to work as well or better than radio in some applications to be a useful technology; this includes the number of available channels, and range (which includes distance at a given power level and data rate). There are a variety of step sizes possible by changing the rise rate of the step. Using different rise rates rejects other signals with the same pattern piece length and rate. The receiver has a wave shape recognition circuit to distinguish between the signals with different step rise rates.

Note 11. In order to be a feasible method of communication, step communication must not interfere with radio. The step spacing pattern must not contain any repeating patterns and the rate of repeating the pieces of the spacing pattern needs to be a frequency too low to be of value in the radio spectrum (such as 10 kHz). The step contains no frequency. Regularly repeating steps may manage to cause a weak response in a radio at the step repeat rate (steps per second=frequency); to prevent this possibility the steps are spaced according to the spacing pattern. In other words, the decimal equivalent of the reversed binary results in a non-repeating, non-natural number sequence so it somewhat resembles noise, and would not be confused for a normal radio signal. But when this entire sequence is repeated and combined with the averager, it begins to stand out against the random noise of the background.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What is claimed is:

1. A communication method comprising:
a transmitting method comprising
creating a series of repeated pieces of a time-spacing pattern that contains no repeated spacing sizes or patterns;
creating a plurality of step wave shapes spaced according to said repeated pieces of said time-spacing pattern;
converting said step wave shapes into a plurality of electromagnetic waves;
a receiving method comprising
converting said electromagnetic waves into an electrical signal;
wherein said step wave shape is recognized in said electrical signal;
wherein said series of repeated pieces of the time-spacing pattern is recognized in the step wave shapes;
whereby data can be encoded by introducing variation into said step wave shapes, to change one or more properties of said time-spacing pattern, or change the amplitude of portions of said time-spacing pattern.

2. The communication method of claim 1, wherein said step wave shapes have a curved top;

3. The communication method of claim 1, wherein a plurality of step-spacing pattern piece lengths and rates define a step wave spectrum.

4. The communication method of claim 3, wherein said step wave shapes have a step rise rate, and wherein a plurality of said step rise rates define an additional parameter to the step wave spectrum, increasing its size.

5. The communication method of claim 1, wherein said data is encoded by spacing modulation of the step wave shapes.

6. The communication method of claim 1, wherein said data is encoded by amplitude modulation of said step wave shapes.

7. The communication method of claim 1, wherein said data is encoded by alternating a transmission of said step wave shapes between on and off.

8. The communication method of claim 1, wherein said time-spacing pattern is based on an inverted binary counting sequence.

9. The communication method of claim 1, wherein said data is encoded by modifying individual steps within the time-spacing pattern.

10. The communication method of claim 1, wherein said data is encoded by using multiple different time-spacing patterns in a parallel data format; the transmitting method has multiple time-spacing plans; and the receiving method recognizes multiple time-spacing plans.

11. The communication method of claim 1, wherein said electromagnetic waves reflect off surfaces before reaching a receiver antenna.

12. The communication method of claim 11, wherein said receiver antenna and a transmitter antenna comprise a single antenna.

13. The communication method of claim 11, wherein the reflections are used for radar.

14. The communication method of claim 11, wherein the reflections are used for ground penetration.

15. The communication method of claim 11, wherein the reflections are used for imaging.

16. The communication method of claim 11, wherein the reflections are used for material recognition; and the receiving step further comprises multiple wave shape recognition methods.

17. A communication apparatus that uses the communication method of claim 1.

18. A communication apparatus that uses the communication method of claim 1 comprising
a transmitting apparatus comprising
a first clock having at least one clock cycle, and at least one binary counter timed by said first clock;
a transmitter antenna;
a memory containing the length and execution rate of said pieces;
a first sequencer that creates a number pattern that is the reversed binary number from said binary counter timed by said clock;
wherein said first sequencer creates the said piece of the said length from the said number pattern;
wherein said first sequencer repeats said piece of said number pattern to create a repeating piece of said number pattern;
wherein said first sequencer creates a first time-spacing pattern that is a series of time spaces equal to a number of clock cycles assigned to each time space dictated by said repeating piece of said number pattern;
a power source that creates one or more step waves, each step wave having an initial level, having a curved top up to a maximum level and a slow recovery back down to said initial level;
wherein said step waves are spaced according to said first time-spacing pattern;
wherein said antenna converts said step waves into a plurality of step electromagnetic waves;
a receiving apparatus comprising
a receiver antenna to convert said step electromagnetic waves to a plurality of electrical signals;
a step wave shape recognition circuit that recognizes said electrical signals;
an automatic gain control circuit that controls the amplitude of the said recognized signals;
a second clock having at least one clock cycle and at least one binary counter timed by said second clock;
a memory containing the length of the piece of the number pattern and the execution rate of said piece;
a second sequencer that creates said number pattern that is the reversed binary number from the binary counter timed by said second clock;
wherein said second sequencer that creates a repeating piece of said number pattern;
wherein said second sequencer creates a second time-spacing pattern that is a series of time spaces equal to the number of said clock cycles assigned to each time space dictated by said repeating piece;
a phase-lock-loop circuit that compares said second time-spacing pattern with the said first time-spacing pattern of said recognized signal to adjust the said second clock to synchronize said second time-spacing pattern with said first time-spacing pattern.
